(19) United States
(12) Patent Application Publication
(10) Pub. No.: US 2021/0256369 A1
(43) Pub. Date: Aug. 19, 2021

(54) DOMAIN-ADAPTED CLASSIFIER GENERATION

(71) Applicant: SparkCognition, Inc., Austin, TX (US)

(72) Inventors: Alexandre Ardel, Austin, TX (US); Shashank Bassi, Austin, TX (US); Elmira M Bonab, Austin, TX (US); Jeff Brown, Cedar Park, TX (US); Angad Chandorkar, Santa Clara, CA (US)

(73) Assignee: SparkCognition, Inc.

(21) Appl. No.: 16/793,832

(22) Filed: Feb. 18, 2020

(51) Int. Cl. G06N 3/08; G06N 3/04

(52) U.S. Cl. CPC G06N 3/08; G06N 3/049

(57) ABSTRACT

A method includes receiving time series source data that is associated with a source asset and that includes a set of classification labels. The method also includes receiving time series target data that is associated with a target asset and that lacks classification labels. The method further includes determining time series representations from the time series source data and the time series target data. The method also includes, based on the set of classification labels included in the time series source data and at least on raw time series data or the time series representations, generating a classifier operable to classify unlabeled data associated with the target asset. The raw time series data includes the time series source data and the time series target data.

### FIELD

The present disclosure is generally related to domain-adapted classifier generation.

### BACKGROUND

An asset time-series data classifier is a data model that is used to evaluate time-series data associated with an asset and assign labels (e.g., categories) to the time-series data. For example, an asset can include an industrial asset, the time-series data can include data generated by one or more sensors (e.g., temperature sensors), and the labels can indicate whether the time-series data corresponds to a normal state or an alarm condition for the asset. Typically, a classifier for an asset is trained based on a set of labeled time-series data associated with the asset. The set of time-series data used for training is usually labeled by a human expert. A classifier trained for one asset is usually not able to correctly label time-series data associated with another asset. Labeling time-series data for training classifiers for each asset can be expensive and time consuming.

### SUMMARY

In a particular aspect, a method includes receiving time series source data that is associated with a source asset and that includes a set of classification labels. The method also includes receiving time series target data that is associated with a target asset and that lacks classification labels. The method further includes determining time series representations from the time series source data and the time series target data. The method also includes, based on the set of classification labels included in the time series source data and further based on at least raw time series data or the time series representations, generating a classifier operable to classify unlabeled data associated with the target asset. The raw time series data includes the time series source data and the time series target data.

In another particular aspect, a computing device includes a processor configured to receive time series source data that is associated with a source asset and that includes a set of classification labels. The processor is also configured to receive time series target data that is associated with a target asset and that lacks classification labels. The processor is further configured to determine time series representations from the time series source data and the time series target data. The processor is also configured to, based on the set of classification labels included in the time series source data and further based on at least raw time series data or the time series representations, generate a classifier operable to classify unlabeled data associated with the target asset. The raw time series data includes the time series source data and the time series target data.

In another particular aspect, a computer-readable storage device stores instructions that, when executed by a processor, cause the processor to receive time series source data that is associated with a source asset and that includes a set of classification labels. The instructions, when executed by the processor, also cause the processor to receive time series target data that is associated with a target asset and that lacks classification labels. The instructions, when executed by the processor, further cause the processor to determine time series representations from the time series source data and the time series target data. The instructions, when executed by the processor, also cause the processor to, based on the set of classification labels included in the time series source data and further based on at least raw time series data or the time series representations, generate a classifier operable to classify unlabeled data associated with the target asset. The raw time series data includes the time series source data and the time series target data.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a block diagram that illustrates an example of a system configured to generate a domain-adapted classifier;

FIG. 2 is a diagram that illustrates an example of time series representations that may be generated by the system of FIG. 1;

FIG. 3 is a diagram that illustrates an example of labeled source data and unlabeled target data that may be processed by the system of FIG. 1;

FIG. 4 is a diagram that illustrates an example of data clustering that may be performed by the system of FIG. 1;

FIG. 5 is a diagram that illustrates an example of data assembling that may be performed by the system of FIG. 1;

FIG. 6 is a diagram that illustrates an example of classifier generation that may be performed by the system of FIG. 1;

FIG. 7 is a diagram that illustrates an example of classifier generation that may be performed by the system of FIG. 1;

FIG. 8 is a diagram that illustrates an example of optimization that may be performed by the system of FIG. 1;

FIG. 9 is a diagram that illustrates an example of cross-validation that may be performed by the system of FIG. 1;

FIG. 10 is a diagram that illustrates an example of data classification that may be performed by the classifier generated by the system of FIG. 1; and

FIG. 11 is a flow chart of an example of a method of domain-adapted classifier generation.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically or communicatively coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical or other signals (e.g., digital signals or analog signals) directly or indirectly, such as via one or more wires, buses, wired or wireless networks, etc. As used herein, “directly coupled” may include two devices that are coupled (e.g., communicatively coupled, electrically coupled, or physically coupled) without intervening components.

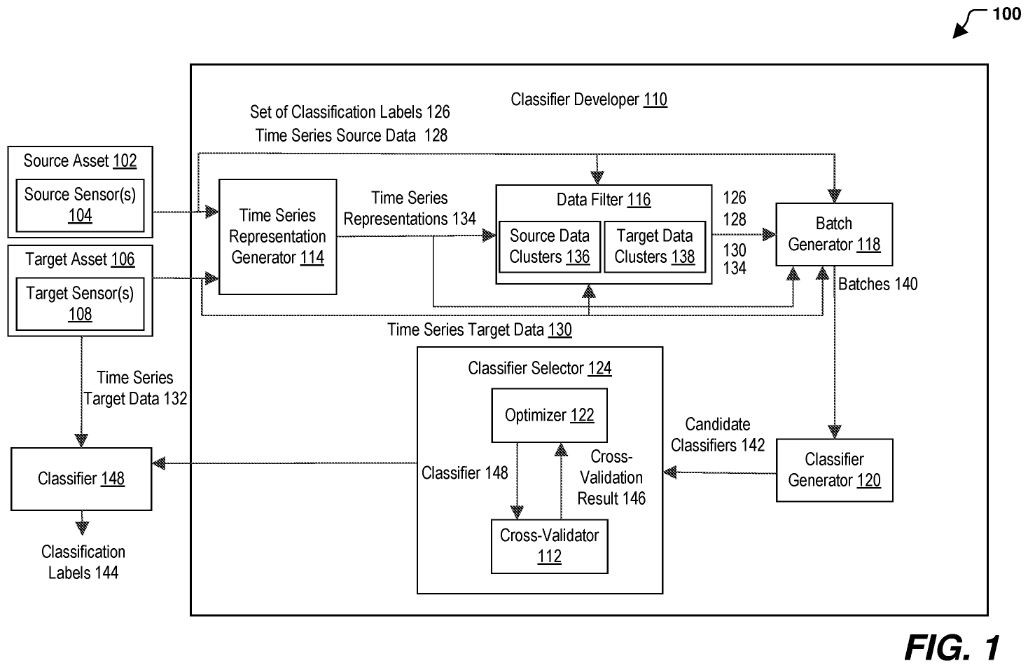

Referring to FIG. 1, a system operable to generate a domain-adapted classifier is shown and generally designated 100. The system 100 comprises a source asset 102 and a target asset 106 coupled to a classifier developer 110. In a particular aspect, the source asset 102 includes, or is coupled to, one or more source sensor(s) 104. In a particular aspect, one or more of the source sensor(s) 104 are proximate to the source asset 102. In a particular aspect, the target asset 106 includes, or is coupled to, one or more target sensor(s) 108. In a particular aspect, one or more of the target sensor(s) 108 are proximate to the target asset 106. In a particular example, an asset includes an industrial asset, such as a factory component, that is coupled to or proximate to one or more sensors, such as a temperature sensor, a humidity sensor, a pressure sensor, a flow sensor, an image sensor, a microphone, a motion sensor, or a combination thereof. In a particular example, the source asset 102 is an asset for which labeled time-series data is available, and the target asset 106 is an asset for which unlabeled data is available and for which a classifier to classify the unlabeled data is to be generated. In a particular aspect, one or more components of the classifier developer 110 are included in one or more processors. In a particular aspect, one or more components of the system 100 are integrated into a computing device.

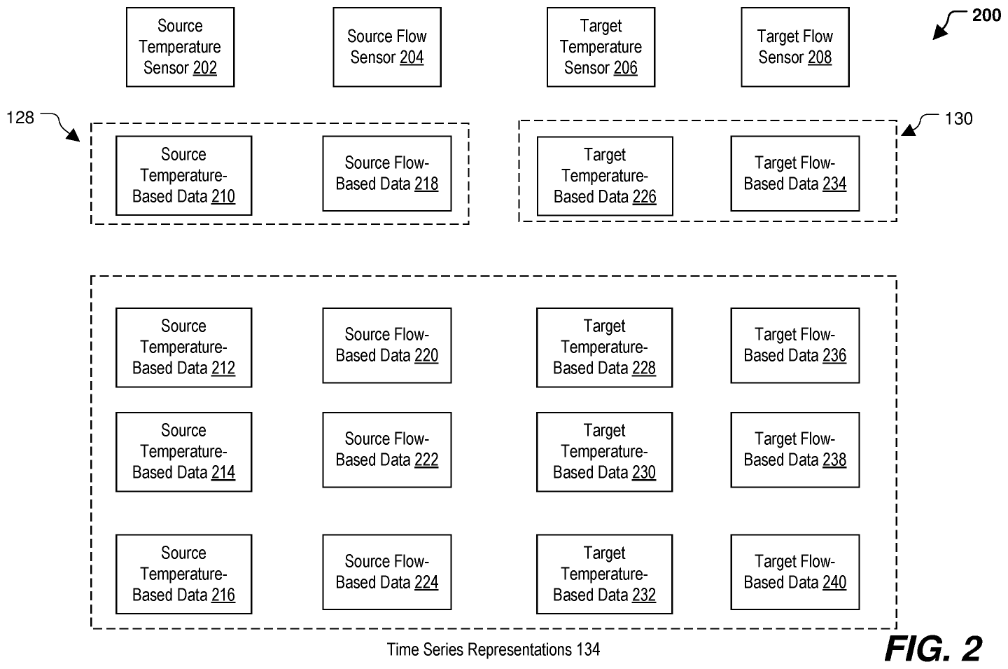

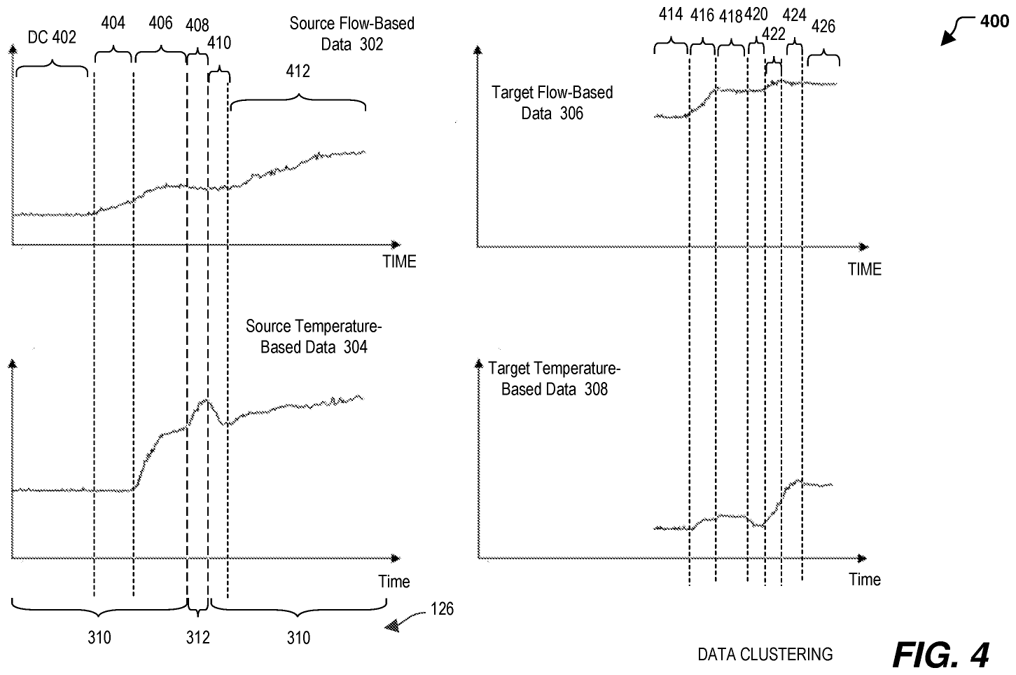

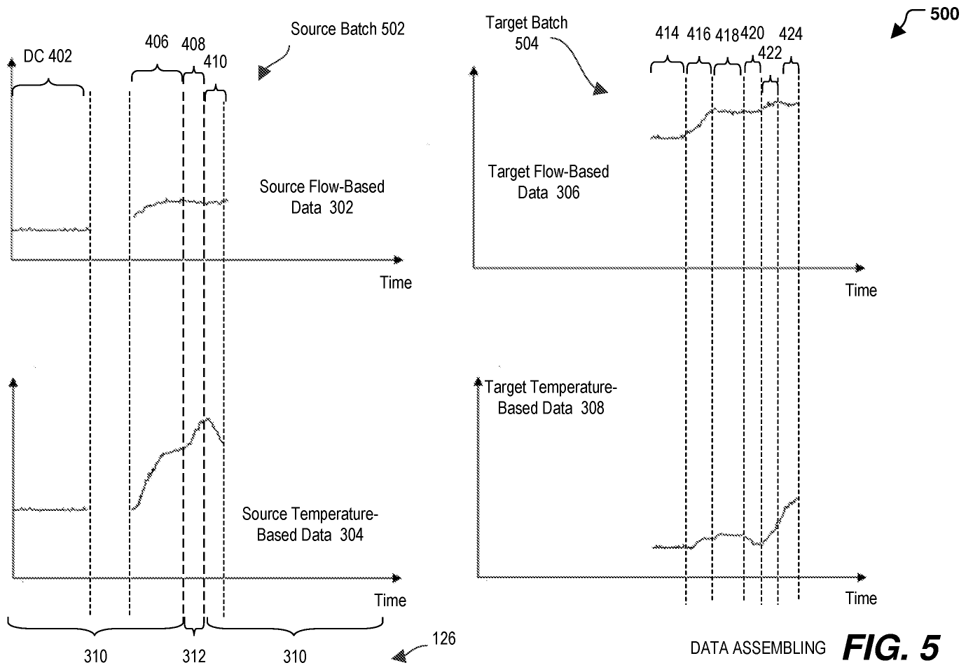

The classifier developer 110 includes a time series representation generator 114, a data filter 116, a batch generator 118, a classifier generator 120, a classifier selector 124, or a combination thereof. The time series representation generator 114 is configured to generate one or more time series representations of time-series data received from the source sensor(s) 104, time-series data received from the target sensor(s) 108, or a combination thereof, as further described with reference to FIG. 2. The data filter 116 is configured to filter out invalid or non-usable data, if any, as further described with reference to FIG. 4. In some implementations, the classifier developer 110 does not include the data filter 116. For example, the batch generator 118 may receive unfiltered data from the source sensor(s) 104, the target sensor(s) 108, the time series representation generator 114, or a combination thereof. The batch generator 118 is configured to assemble data received from the source sensor(s) 104, the target sensor(s) 108, the time series representation generator 114, the data filter 116, or a combination thereof, into batches, as further described with reference to FIG. 5.

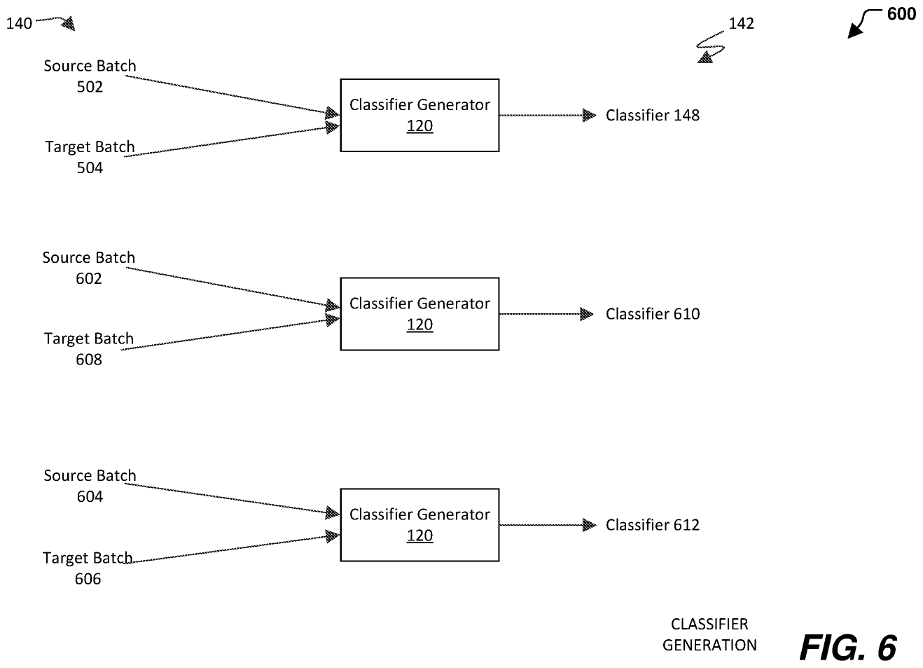

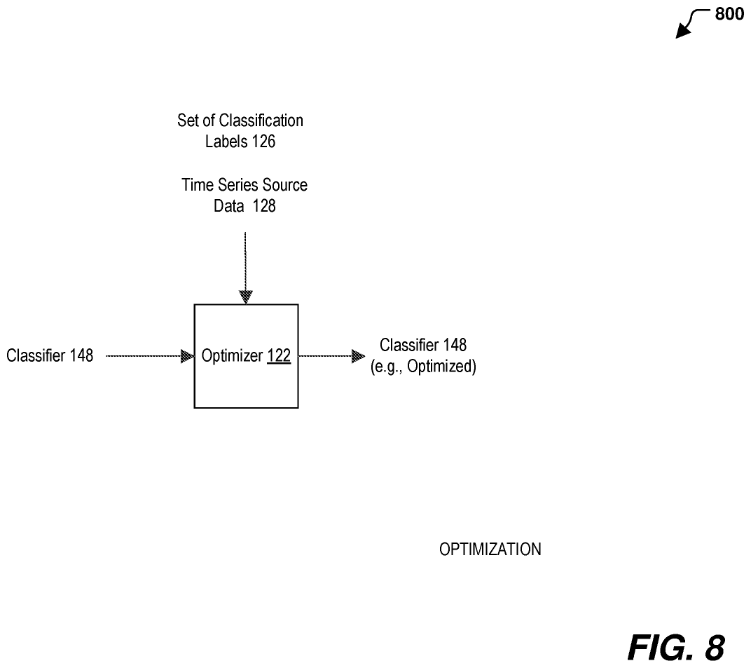

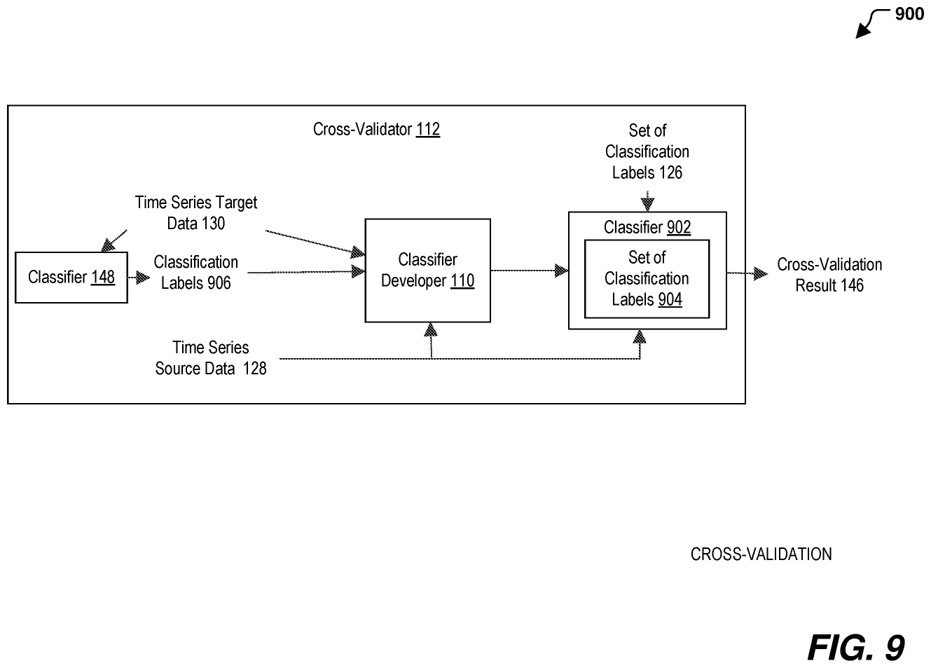

The classifier generator 120 is configured to generate classifiers based on the batches of data, as further described with reference to FIG. 6. The classifier selector 124 includes an optimizer 122, a cross-validator 112, or both. The optimizer 122 is configured to adjust hyperparameters of a neural network of the classifier, as further described with reference to FIG. 8. The cross-validator 112 is configured to cross-validate a target classifier for the target asset 106 by comparing labels received with the source asset data to labels generated by a source classifier, the source classifier generated at least in part based on target labels generated by the target classifier, as further described with reference to FIG. 9.

During operation, the time series representation generator 114 receives time series source data 128 and time series target data 130. The time series source data 128 is generated by the source sensor(s) 104, and the time series target data 130 is generated by the target sensor(s) 108. In a particular aspect, the time series source data 128 represents sensor data (e.g., measurements, images, etc.) collected by the source sensor(s) 104 over various time periods during operation of the source asset 102, and the time series target data 130 represents sensor data collected by the target sensor(s) 108 over various time periods during operation of the target asset 106. In a particular aspect, the time series source data 128 represents sensor data collected over a longer time period than the time series target data 130. As used herein, “raw time series data” refers to the time series source data 128, the time series target data 130, or a combination thereof.

The time series source data 128 includes or is associated with a set of classification labels 126. For example, the set of classification labels 126 indicates that a particular classification label is assigned to a particular portion of the time series source data 128. To illustrate, an expert (e.g., an engineer or a subject matter expert) reviews the time series source data 128 and determines that a particular portion of the time series source data 128 generated during a particular time period corresponds to a particular mode of operation (e.g., “regular operating conditions”, “medium alarm conditions”, or “high alarm conditions,” as non-limiting examples). The expert assigns a particular classification label indicating the particular mode of operation to the particular portion of the time series source data 128. The time series target data 130 corresponds to unlabeled data. For example, the time series target data 130 does not include and is not associated with any classification labels.

The time series representation generator 114 generates time series representations 134 of the time series source data 128, the time series target data 130, or a combination thereof, as further described with reference to FIG. 2. For example, the time series representations 134 can include, but are not limited to standard deviation values, average values, frequency-domain values (such as fast Fourier transform (FFT) power components or third octave components), time-domain values, symbolic approximation values, time series as images, or a combination thereof. In a particular aspect, the time series source data 128, the time series target data 130, and the time series representations 134 correspond to a library of data that is available for use in generating various candidate classifiers for classifying unlabeled data of the target sensor(s) 108. The time series representation generator 114 provides the time series representations 134 to the data filter 116, the batch generator 118, or both.

In some implementations, the data filter 116 processes the time series source data 128, the time series target data 130, the time series representations 134, or a combination thereof, as further described with reference to FIG. 4, and provides the processed (e.g., pre-processed or filtered) versions of the time series source data 128, the time series target data 130, the time series representations 134, or a combination thereof, to the batch generator 118. In a particular implementation, the data filter 116 filters out a subset of the received data. For example, the data filter 116 generates source data clusters 136 based on the time series source data 128, a subset of the time series representations 134 that is based on the time series source data 128, or a combination thereof. As another example, the data filter 116 generates target data clusters 138 based on the time series target data 130, a subset of the time series representations 134 that is based on the time series target data 130, or a combination thereof. The data filter 116 uses data analysis techniques to identify a subset of the source data clusters 136, a subset of the target data clusters 138, or a combination thereof.

In a particular implementation, the identified subset includes clusters that appear to be non-usable (e.g., outliers). In a particular implementation, the data filter 116 removes (e.g., filters) data corresponding to the identified subset to generate the processed versions of the time series source data 128, the time series target data 130, the time series representations 134, or a combination thereof. In a particular aspect, the data filter 116 generates an output indicating the identified subset and selectively removes data corresponding to the identified subset based on user input. For example, the output indicates that a first cluster of the source data clusters 136 corresponds to non-usable data. The output is provided to a display, a device associated with a user, or both. The data filter 116, in response to receiving a first user input indicating that the first cluster is to be disregarded, removes at least data corresponding to the first cluster to generate the processed version of the time series source data 128, the processed version of the time series representations 134, or a combination thereof. Alternatively, the data filter 116, in response to receiving a second user input indicating that the first cluster is to be considered, refrains from removing the data associated with the first cluster to generate the processed version of the time series source data 128, the processed version of the time series representations 134, or a combination thereof.

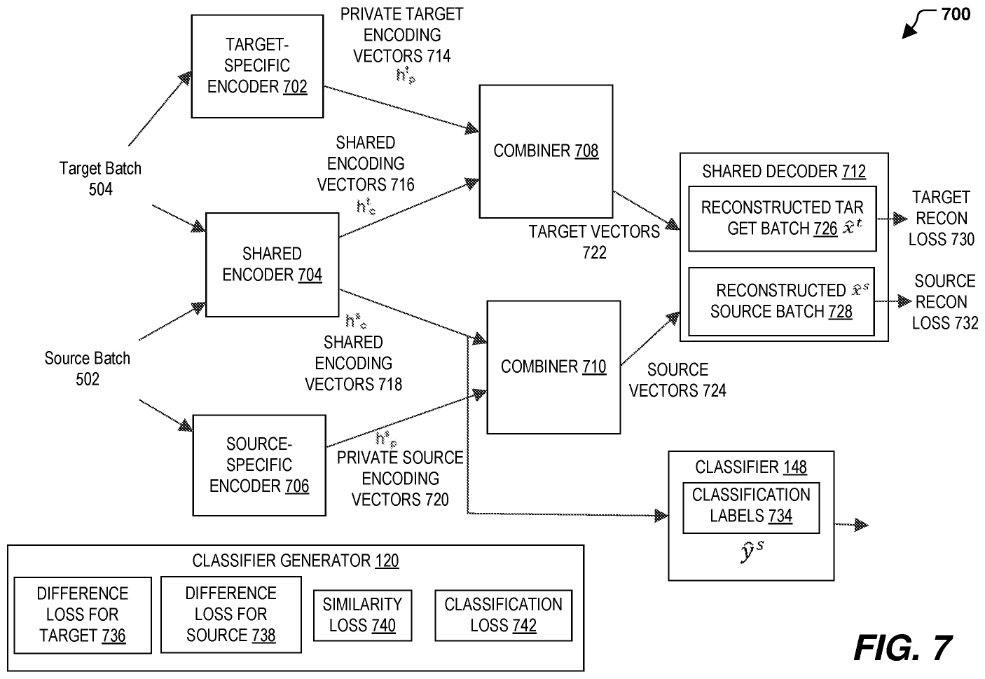

The batch generator 118 receives processed or unprocessed versions of the set of classification labels 126, the time series source data 128, the time series target data 130, the time series representations 134, or a combination thereof, and assembles the received data into one or more batches 140, as further described with reference to FIG. 5. For example, a first batch of the time series source data 128 includes data associated with a first time period and a second batch of the time series source data 128 includes data associated with a second time period. The batch generator 118 provides the batches 140 to the classifier generator 120. The classifier generator 120 generates one or more candidate classifiers 142 based on the batches 140, as further described with reference to FIG. 6 and FIG. 7. For example, the classifier generator 120 generates a first classifier based on a first batch of the time series source data 128 and a first batch of the time series target data 130, and a second classifier based on a second batch of the time series source data 128 and a second batch of the time series target data 130. The classifier generator 120 provides the candidate classifiers 142 to the classifier selector 124.

The optimizer 122, the cross-validator 112, or both, process the candidate classifiers 142. In a particular example, the optimizer 122 optimizes a classifier 148 of the candidate classifiers 142, as further described with reference to FIG. 8. In a particular example, the cross-validator 112 cross-validates the classifier 148, as further described with reference to FIG. 9. For example, the cross-validator 112 generates a cross-validation result 146 by analyzing the classifier 148, as further described with reference to FIG. 9. The cross-validator 112 determines that the classifier 148 has been successfully cross-validated in response to determining that the cross-validation result 146 satisfies (e.g., is greater than) a cross-validation criterion (e.g., a cross-validation threshold).

In a particular implementation, the classifier selector 124 outputs the classifier 148 successfully cross-validated by the cross-validator 112 without the classifier 148 having been optimized by the optimizer 122. In another particular implementation, the optimizer 122 optimizes the classifier 148, the cross-validator 112 cross-validates the optimized version of the classifier 148, and the classifier selector 124 outputs the optimized version of the classifier 148 subsequent to a successful cross-validation. In another particular implementation, the cross-validator 112 cross-validates the classifier 148, the optimizer 122 optimizes the classifier 148 subsequent to a successful cross-validation, and the classifier selector 124 outputs the optimized version of the classifier 148. In a particular aspect, the classifier selector 124 discards (e.g., refrains from optimizing or outputting) the classifier 148 in response to determining that the classifier 148 has failed the cross-validation (e.g., the cross-validation result 146 has failed to satisfy the cross-validation criterion). In a particular implementation, the classifier selector 124 outputs the classifier 148 optimized by the optimizer 122 without the cross-validator 112 cross-validating the classifier 148.

The classifier 148 is operable to generate labels for unlabeled data corresponding to the target asset 106. For example, the classifier 148 generates one or more classification labels 144 for time series target data 132 received from the target sensor(s) 108. In a particular aspect, the time series target data 132 is the same as or distinct from the time series target data 130. In a particular aspect, the classifier 148 generates the classification labels 144 in real-time as the time series target data 132 is received from the target sensor(s) 108. Having the classifier 148 generate labels for unlabeled data saves resources and increases accuracy. For example, training the classifier 148 and generating the labels for the unlabeled data can be faster and less expensive than having a human expert analyzing the unlabeled data. In addition, the classifier 148 may be trained to give more weight to certain relevant factors that the human expert does not realize are important, and thus generate more accurate labels. Using domain adaptation to generate the classifier 148 reduces (e.g., removes) a dependence on having a large set of labeled data for the target asset 106 for training the classifier 148. For example, the time series source data 128 can be used to train classifiers associated with various target assets without having labeled data for the target assets. As a result, classifiers can be generated and deployed more efficiently for multiple target assets as compared to having a human expert analyzing unlabeled data for each of the target assets to train classifiers for the target assets.

The system 100 thus enables generation of a domain-adapted classifier, such as the classifier 148 adapted to the target asset 106, that does not rely on labeled data for the target asset 106 for training. For example, the classifier developer 110 can automatically generate classifiers associated with multiple target assets, with each classifier adapted to a particular target asset, based on the set of classification labels 126, the time series source data 128, and unlabeled data associated with the corresponding target asset.

Referring to FIG. 2, an example of the time series source data 128, the time series target data 130, and the time series representations 134 is shown and generally designated example 200. In a particular aspect, the source sensor(s) 104 include a source temperature sensor 202 and a source flow sensor 204, and the target sensor(s) 108 include a target temperature sensor 206 and a target flow sensor 208. In a particular aspect, the target temperature sensor 206 is a similar type of sensor as the source temperature sensor 202, the target flow sensor 208 is a similar type of sensor as the source flow sensor 204, or both. For example, the source temperature sensor 202 and the target temperature sensor 206 have the same manufacturer, same sensor type (e.g., temperature sensor), same model, or a combination thereof.

The time series source data 128 includes source temperature-based data 210 and source flow-based data 218 generated by the source temperature sensor 202 and the source flow sensor 204, respectively. The time series target data 130 includes target temperature-based data 226 and target flow-based data 234 generated by the target temperature sensor 206 and the target flow sensor 208, respectively.

The time series representations 134 include source temperature-based data 212, source temperature-based data 214, and source temperature-based data 216 corresponding to various time series representations of the source temperature-based data 210. For example, the time series representations 134 can include, but are not limited to, standard deviation values, average values, frequency-domain values (such as FFT power components or third octave components), time-domain values, symbolic approximation values, time series as images, or a combination thereof. Similarly, the time series representations 134 can include source flow-based data (e.g., source flow-based data 220, source flow-based data 222, or source flow-based data 224) corresponding to various time series representations of the source flow-based data 218. In addition, the time series representations 134 can include target temperature-based data (e.g., target temperature-based data 228, target temperature-based data 230, or target temperature-based data 232) corresponding to various time series representations of the target temperature-based data 226. In a particular aspect, the time series representations 134 can include target flow-based data (e.g., target flow-based data 236, target flow-based data 238, or target flow-based data 240) corresponding to various time series representations of the target flow-based data 234. It should be understood that three time series representations of each type of sensor data is shown as an illustrative example. The time series representations 134 enable the classifier 148 to be generated based on various levels of data abstraction.

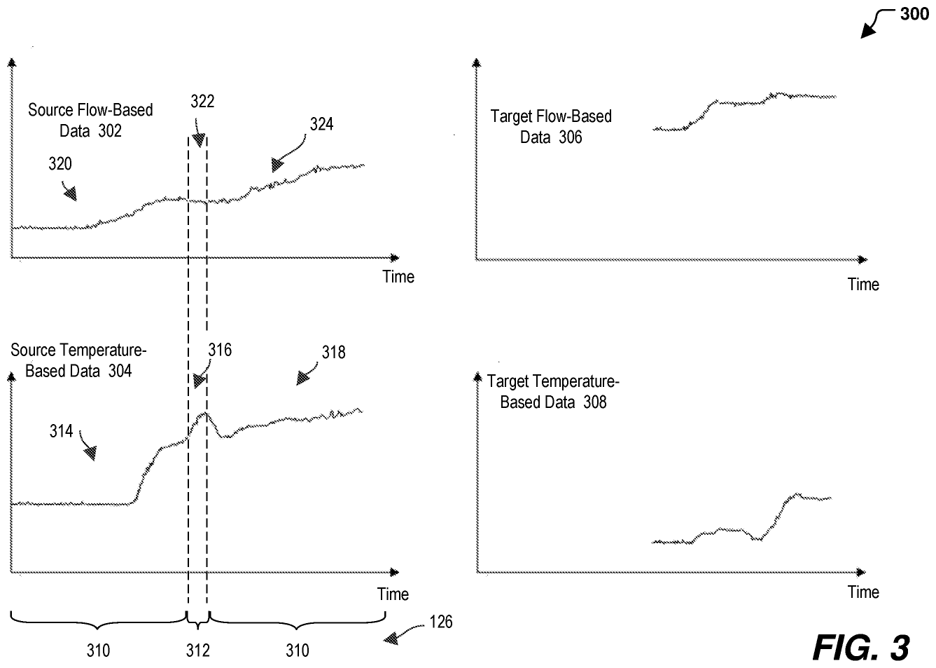

Referring to FIG. 3, an example of labeled source data and unlabeled target data is shown and generally designated as example 300. In a particular aspect, the example 300 includes graphs depicting source flow-based data 302, source temperature-based data 304, target flow-based data 306, and target temperature-based data 308. For example, the source temperature-based data 304 includes sensor data (e.g., the source temperature-based data 210), the time series representations 134 (e.g., the source temperature-based data 212, the source temperature-based data 214, or the source temperature-based data 216) generated based on the sensor data, or a combination thereof. As another example, the target temperature-based data 308 includes sensor data (e.g., the target temperature-based data 226), the time series representations 134 (e.g., the target temperature-based data 228, the target temperature-based data 230, or the target temperature-based data 232) generated based on the sensor data, or a combination thereof.

The classifier developer 110 processes sensor data (e.g., the time series source data 128, the time series target data 130, or both), the time series representations 134 based on the sensor data, or a combination thereof. In a particular aspect, the set of classification labels 126 indicates that a classification label 310 is assigned to a first portion of the time series source data 128 generated during a first time period. For example, the classification label 310 (e.g., “regular operation”) indicates that the source asset 102 is designated, based on the first portion of the time series source data 128, as operating in a first mode (e.g., a regular operation mode) during the first time period. The time series representation generator 114 associates the classification label 310 (e.g., “regular operation”) to a first portion 320 of the source flow-based data 302 and a first portion 314 of the source temperature-based data 304 that correspond to the first portion of the time series source data 128 (e.g., the first time period). For example, a data structure (e.g., a row in a table) indicates that the classification label 310 has been assigned by an expert to the first portion of the time series source data 128, and the time series representation generator 114 adds an indication of the first portion 320 of the source flow-based data 302 and an indication of the first portion 314 of the source temperature-based data 304 to the data structure.

In a particular example, the set of classification labels 126 indicates that a classification label 312 is assigned to a second portion of the time series source data 128 generated during a second time period. For example, an expert (e.g., an engineer) assigns the classification label 312 (e.g., a specific operating mode) to the second portion of the time series source data 128 in response to determining that a second portion 316 of the source temperature-based data 304 indicates a rising temperature while a second portion 322 of the source flow-based data 322 indicates constant or decreasing flow during the same time period (e.g., the second time period). The time series representation generator 114 associates the classification label 312 to the second portion 322 of the source flow-based data 302 and the second portion 316 of the source temperature-based data 304 that correspond to the second portion of the time series source data 128 (e.g., the second time period).

In a particular aspect, the same classification may be assigned to multiple portions of the time series source data 128. For example, the set of classification labels 126 indicates that the classification label 310 is assigned to a third portion of the time series source data 128 generated during a third time period in addition to the first portion of the time series source data 128. To illustrate, an expert (e.g., an engineer) assigns the classification label 310 to the third portion of the time series source data 128 in response to determining that a third portion 318 of the source temperature-based data 304 indicates a rising temperature while a third portion 324 of the source flow-based data 322 indicates rising flow during the same time period (e.g., the third time period). The time series representation generator 114 associates the classification label 310 to the third portion 324 of the source flow-based data 302 and the third portion 318 of the source temperature-based data 304 that correspond to the third portion of the time series source data 128 (e.g., the third time period).

Referring to FIG. 4, an example of data clustering is shown and generally designated as an example 400. For example, the data filter 116 of FIG. 1 performs various data clustering techniques to generate the source data clusters 136 and the target data clusters 138 based on the time series source data 128, the time series target data 130, the time series representations 134, or a combination thereof.

In a particular aspect, the data filter 116 generates one or more clusters based on a relationship between flow sensor data and temperature sensor data. For example, the data filter 116 generates a data cluster (“DC”) 402 that corresponds to a steady flow indicated by a particular portion of the source flow-based data 302 and a steady temperature indicated by a particular portion of the source temperature-based data 304 during a particular time period. In a particular example, the data filter 116 generates a data cluster 404 that corresponds to an increasing flow indicated by a particular portion of the source flow-based data 302 and a steady temperature indicated by a particular portion of the source temperature-based data 304 during a second time period.

In a particular example, the data filter 116 generates a data cluster 406 that corresponds to an increasing flow indicated by a particular portion of the source flow-based data 302 and an increasing temperature indicated by a particular portion of the source temperature-based data 304 during a third time period. In a particular example, the data filter 116 generates a data cluster 408 that corresponds to a steady flow indicated by a particular portion of the source flow-based data 302 and an increasing temperature indicated by a particular portion of the source temperature-based data 304 during a fourth time period. In a particular example, the data filter 116 generates a data cluster 410 that corresponds to a steady flow indicated by a particular portion of the source flow-based data 302 and a decreasing temperature indicated by a particular portion of the source temperature-based data 304 during a fifth time period. In a particular example, the data filter 116 generates a data cluster 412 that corresponds to an increasing flow indicated by a particular portion of the source flow-based data 302 and an increasing temperature indicated by a particular portion of the source temperature-based data 304 during a fourth time period.

In a particular aspect, the data filter 116 generates one or more data clusters based on the target flow-based data 306 and the target temperature-based data 308. For example, the data filter 116 generates a data cluster 414 that corresponds to a steady flow indicated by a particular portion of the target flow-based data 306 and a steady temperature indicated by a particular portion of the target temperature-based data 308 during a first time period. In a particular example, the data filter 116 generates a data cluster 416 that corresponds to an increasing flow indicated by a particular portion of the target flow-based data 306 and an increasing temperature indicated by a particular portion of the target temperature-based data 308 during a second time period.

In a particular example, the data filter 116 generates a data cluster 418 that corresponds to a steady flow indicated by a particular portion of the target flow-based data 306 and a steady temperature indicated by a particular portion of the target temperature-based data 308 during a third time period. In a particular example, the data filter 116 generates a data cluster 420 that corresponds to a steady flow indicated by a particular portion of the target flow-based data 306 and a decreasing temperature indicated by a particular portion of the target temperature-based data 308 during a fourth time period. In a particular example, the data filter 116 generates a data cluster 422 that corresponds to an increasing flow indicated by a particular portion of the target flow-based data 306 and an increasing temperature indicated by a particular portion of the target temperature-based data 308 during a fifth time period.

In a particular example, the data filter 116 generates a data cluster 424 that corresponds to a steady flow indicated by a particular portion of the target flow-based data 306 and an increasing temperature indicated by a particular portion of the target temperature-based data 308 during a sixth time period. In a particular example, the data filter 116 generates a data cluster 426 that corresponds to a steady flow indicated by a particular portion of the target flow-based data 306 and a steady temperature indicated by a particular portion of the target temperature-based data 308 during a seventh time period.

In a particular aspect, the data filter 116 identifies a subset of the source data clusters 136, the target data clusters 138, or a combination thereof, as corresponding to non-usable data (e.g., outliers). For example, a data cluster corresponds to non-usable data if the data cluster indicates a relationship that is a statistical outlier. To illustrate, the data filter 116 identifies the data cluster 404 and the data cluster 412 as corresponding to non-usable data.

The data filter 116 generates filtered data by removing data corresponding to the identified subsets (e.g., non-usable) from the time series source data 128, the time series target data 130, the time series representations 134, or a combination thereof, and provides the filtered data to the batch generator 118. For example, the data filter 116 generates filtered versions of the source flow-based data 302 and the source temperature-based data 304 by removing data corresponding to the data cluster 404 and the data cluster 412 from the source flow-based data 302 and the source temperature-based data 304, and provides the filtered versions of the source flow-based data 302 and the source temperature-based data 304 to the batch generator 118.

In a particular aspect, rather than automatically removing a subset of data clusters that are identified as non-usable, the data filter 116 generates an output indicating the identified subset of data clusters. For example, the output indicates one or more data clusters (e.g., the data cluster 404 and the data cluster 412) identified as corresponding to non-usable data. The data filter 116 provides the output to a display, a device associated with a user, or both. The data filter 116 selectively filters the time series source data 128, the time series target data 130, the time series representations 134, or a combination thereof, based on user input responsive to the output. For example, the data filter 116, in response to receiving a first user input indicating that the data cluster 404 is to be removed, generates filtered versions of the source flow-based data 302 and the source temperature-based data 304 by removing data corresponding to the data cluster 404. Alternatively, the data filter 116, in response to receiving a second user input indicating that the data cluster 404 is not to be removed, retains data corresponding to the data cluster 404 in versions of the source flow-based data 302 and the source temperature-based data 304 that are provided to the batch generator 118.

The data clustering thus enables the data filter 116 to identify non-usable data. In some implementations, the non-usable data is discarded to remove outliers from data that is to be used to generate a classifier.

Referring to FIG. 5, an example of data assembling is shown and generally designated as example 500. The batch generator 118 of FIG. 1 performs data assembling by generating one or more batches 140 based on the time series source data 128, the time series target data 130, the time series representations 134, or a combination thereof. In a particular aspect, the batch generator 118 generates the batches 140 based on versions (e.g., filtered or unfiltered versions) of the time series source data 128, the time series target data 130, the time series representations 134, or a combination thereof, received from the data filter 116.

As an example, the batch generator 118 selects various portions of the source flow-based data 302 and corresponding portions of the source temperature-based data 304 to generate source batches of the batches 140. To illustrate, the batch generator 118 selects one or more portions of the source flow-based data 302 and corresponding portions of the source temperature-based data 304 to generate a source batch 502. Similarly, the batch generator 118 selects various portions of the target flow-based data 306 and corresponding portions of the target temperature-based data 308 to generate target batches of the batches 140. For example, the batch generator 118 selects one or more portions of the target flow-based data 306 and corresponding portions of the target temperature-based data 308 to generate a target batch 504. The batch generator 118 provides the batches 140 to the classifier generator 120.

Referring to FIG. 6, an example of classifier generation is shown and generally designated as example 600. The classifier generator 120 generates the candidate classifiers 142 corresponding to various combinations of source batches and target batches. For example, the classifier generator 120 performs a first classifier generation technique to generate a classifier 148 (e.g., an artificial neural network) based on at least the source batch 502 and the target batch 504. To illustrate, the classifier generator 120 trains the classifier 148 using a first set of source batches that includes at least the source batch 502 and a first set of target batches that includes at least the target batch 504. As another example, the classifier generator 120 performs a second classifier generation technique to generate a classifier 610 based on a source batch 602 and a target batch 608. To illustrate, the classifier generator 120 trains the classifier 610 using a second set of source batches that includes at least the source batch 602 and a second set of target batches that includes at least the target batch 608. In a particular example, the classifier generator 120 performs a third classifier generation technique to generate a classifier 612 based on a source batch 604 and a target batch 606. To illustrate, the classifier generator 120 trains the classifier 612 using a third set of source batches that includes at least the source batch 604 and a third set of target batches that includes at least the target batch 606.

In a particular implementation, distinct sets of source batches and target batches may be used to train each of a plurality of the candidate classifiers 142. For example, the batch generator 118 generates the first set of source batches based on a first portion of the time series source data 128 that corresponds to a first time period and generates a second set of source batches based on a second portion of the time series source data 128 that corresponds to a second time period that is distinct from the first time period. For example, the first portion of the time series source data 128 includes sensor data generated during the first time period, and the second portion of the time series source data 128 includes sensor data generated during the second time period. In a particular aspect, the first time period overlaps the second time period. In a particular aspect, the first time period and the second time period are non-overlapping. In an alternative implementation, identical sets of source batches and target batches may be used to train each of a plurality of the candidate classifiers 142 with distinct hyperparameters for each of the plurality of the candidate classifiers 142. In a particular implementation, distinct sets of source batches, distinct sets of target batches, distinct hyperparameters, or a combination thereof, may be used to train each of a plurality of the candidate classifiers 142.

The candidate classifiers 142 include the classifier 148, the classifier 610, the classifier 612, one or more additional classifiers, or a combination thereof. As used herein, the classifier 148, the classifier 610, and the classifier 612 are referred to as “candidate” classifiers to indicate that the classifier 148, the classifier 610, and the classifier 612 are candidates for use in classifying the time series target data 132. Final selection from among the candidate classifiers 142 may be performed based on cross-validation results, optimization results, etc., as described with reference to the classifier selector 124.

In a particular aspect, the second classifier generation technique used to generate the classifier 610 is the same as or different from the first classifier generation technique used to generate the classifier 148. In a particular implementation, the classifier generator 120 generates each of a first set of the candidate classifiers 142 using a first classifier generation technique and generates each of a second set of the candidate classifiers 142 using a second classifier generation technique. In a particular aspect, the optimizer 122 of FIG. 1 optimizes each of the first set of the candidate classifiers 142 and each of the second set of the candidate classifiers 142, the cross-validator 112 of FIG. 1 cross-validates each of the first set of the candidate classifiers 142 and each of the second set of the candidate classifiers 142, or both. In a particular implementation, the classifier selector 124 selects a first candidate classifier (e.g., optimized, cross-validated, or both) of the first set of candidate classifiers 142 and selects a second candidate classifier (e.g., optimized, cross-validated, or both) of the second set of candidate classifiers 142. In this implementation, the classifier selector 124 selects one of the first candidate classifier or the second candidate classifier based on a comparison of the first candidate classifier and the second candidate classifier. The selected one of the first candidate classifier or the second candidate classifier includes the classifier 148.

In a particular example, the first classifier generation technique, the second classifier generation technique, or both, include but are not limited to, a domain separation network (DSN) based technique, a domain confusion soft labels (DCSL) based technique, a transfer learning with deep autoencoders (TLDA) based technique, a domain adversarial training of neural networks (DANN) based technique, a sharing weights for domain adaptation (SWS) based technique, an incrementally adversarial domain adaptation for continually changing environments (IADA) based technique, a variational fair auto encoder (VFAE) based technique, or a combination thereof. Although three candidate classifiers are illustrated, in other implementations fewer than three or more than three candidate classifiers may be generated. For example, in some implementations, a single candidate classifier may be generated and optimized by the classifier selector 124, and selected for classifying the time series target data 132.

Referring to FIG. 7, an example of classifier generation is shown and generally designated as an example 700. In the example 700, a particular implementation of the classifier generator 120 is illustrated that generates the classifier 148 based on a DSN-based technique for purposes of explanation; however, it should be understood that in other implementations the classifier generator 120 may use one or more other techniques instead of, or in addition to, a DSN-based technique, such as but not limited to DCSL, TLDA, DANN, SWS, IADA, or VFAE-based techniques, as non-limiting examples. For example, the classifier generator 120 provides the target batch 504 to a target-specific encoder 702 and to a shared encoder 704. The classifier generator 120 provides the source batch 502 to the shared encoder 704 and to a source-specific encoder 706.

As described further below, a training process is used to train the shared encoder 704 (e.g., a shared weight encoder) to capture encodings that are similar among the domains (e.g., a domain corresponding to the source asset 102 and a domain corresponding to the target asset 106) to generate shared encoding vectors 716 and shared encoding vectors 718. In a particular example, the source batch 502 includes the source flow-based data 302, the source temperature-based data 304, and source weight-based data, and the target batch 504 includes the target flow-based data 306 and the target temperature-based data 308.

The training process trains the target-specific encoder 702 to generate private target encoding vectors 714 based on the target batch 504. For example, the target-specific encoder 702 generates the private target encoding vectors 714 based on the target flow-based data 306 and the target temperature-based data 308. The source-specific encoder 706 is trained to generate private source encoding vectors 720 based on the source batch 502. For example, the source-specific encoder 706 generates the private source encoding vectors 720 based on the source flow-based data 302, the source temperature-based data 304, and the source weight-based data.

The training process may be based on optimization (e.g., minimization or reduction) of various metrics, such as a target reconstruction loss 730, a source reconstruction loss 732, a difference loss for target 736, a difference loss for source 738, a similarity loss 740, and a classification loss 742. For example, the classifier generator 120 determines a difference loss for target 736 based on a comparison (e.g., an orthogonality measure) of the private target encoding vectors 714 and the shared encoding vectors 716. The classifier generator 120 determines a difference loss for source 738 based on a comparison (e.g., an orthogonality measure) of the shared encoding vectors 718 and the private source encoding vectors 720. The classifier generator 120 determines a similarity loss 740 based on a comparison (e.g., an orthogonality measure) of the shared encoding vectors 716 and the shared encoding vectors 718.

The combiner 708 generates target vectors 722 based on the private target encoding vectors 714 and the shared encoding vectors 716. For example, the target vectors 722 correspond to a combination of the private target encoding vectors 714 and the shared encoding vectors 716. The combiner 710 generates source vectors 724 based on the shared encoding vectors 718 and the private source encoding vectors 720.

The shared decoder 712 generates a reconstructed target batch 726 based on the target vectors 722 and determines a target reconstruction loss 730 based on a comparison of the target batch 504 and the reconstructed target batch 726. For example, the target reconstruction loss 730 indicates a difference between the target batch 504 and the reconstructed target batch 726. The shared decoder 712 generates a reconstructed source batch 728 based on the source vectors 724, and determines a source reconstruction loss 732 based on a comparison of the source batch 502 and the reconstructed source batch 728. For example, the source reconstruction loss 732 indicates a difference between the source batch 502 and the reconstructed source batch 728.

The classifier 148 generates classification labels 734 by classifying the shared encoding vectors 718. The classifier generator 120 determines a classification loss 742 based on a comparison of the classification labels 734 and the set of classification labels 126. In the illustrated example, the classifier generator 120 uses a DSN-based technique to train the classifier 148. For example, the classifier generator 120 trains the target-specific encoder 702, the shared encoder 704, and the source-specific encoder 706 to generate encoding vectors such that the difference loss for target 736, the difference loss for source 738, the similarity loss 740, the target reconstruction loss 730, and the source reconstruction loss 732 are minimized (or reduced). The classifier generator 120 also trains the classifier 148 based on the shared encoding vectors 718 so that the classification loss 742 is minimized (or reduced) over processing of multiple source batches and target batches. In a particular aspect, the classifier generator 120 trains the target-specific encoder 702, the shared encoder 704, the source-specific encoder 706, and the classifier 148 such that a total loss based on a weighted sum of the difference loss for target 736, the difference loss for source 738, the similarity loss 740, the target reconstruction loss 730, the source reconstruction loss 732, the classification loss 742, or a combination thereof, is minimized (or reduced). In a particular aspect, the classifier generator 120 outputs the classifier 148 as a candidate classifier in response to determining that the total loss satisfies a convergence criterion. The classifier generator 120 thus generates a domain-adapted classifier (e.g., the classifier 148) that is adapted to the target asset 106 in the absence of labels for data associated with the target asset 106.

Referring to FIG. 8, an example of optimization is shown and generally designated as an example 800. In a particular aspect, the optimizer 122 updates the classifier 148 based on various neural network optimization techniques to satisfy an optimization criterion. For example, the optimizer 122 updates the classifier 148 by adjusting one or more model hyperparameters, such as, but not limited to, loss weights. To illustrate, the total loss, described with reference to FIG. 7, includes a weighted sum based on applying the loss weights to the difference loss for target 736, the difference loss for source 738, the similarity loss 740, the target reconstruction loss 730, the source reconstruction loss 732, the classification loss 742, or a combination thereof. It should be understood that in some examples the adjustments performed by the optimizer 122 results in an adjusted version of the classifier 148 that may or may not include the most optimal version of the classifier 148.

The optimizer 122 enables optimization of the classifier 148, the candidate classifiers 142, or a combination thereof. The optimization may be performed prior to, subsequent to, or in the absence of any cross-validation. In a particular aspect, the optimizer 122 updates each of the candidate classifiers 142 independently of any cross-validation. In an alternative aspect, the optimizer 122 selectively updates the classifier 148 based on the cross-validation result 146 of FIG. 1. For example, the optimizer 122 selectively updates the classifier 148 based on determining that the cross-validation result 146 indicates that the classifier 148 satisfies a cross-validation criterion. As another example, the optimizer 122 selects the classifier 148 from the candidate classifiers 142 in response to determining that the cross-validation result 146 indicates that the classifier 148 is better at satisfying the cross-validation validation criterion as compared to others of the candidate classifiers 142, e.g., a first cross-validation result for the classifier 148 is higher (or lower) than cross-validation results for other classifiers. The optimizer 122 selectively adjusts the classifier 148 based on determining that the first cross-validation result satisfies the cross-validation criterion. The optimizer 122 thus enables optimization of the classifier 148, the candidate classifiers 142, or a combination thereof, based on optimization techniques.

Referring to FIG. 9, an example of cross-validation is shown and generally designated as an example 900. The cross-validator 112 performs cross-validation to verify performance of (e.g., accuracy of classifiers generated by) the classifier developer 110. Cross-validation can involve using multiple source-target pairs to generate classifiers and comparing labeled data output by one of the generated classifiers for an asset to verified labeled data (e.g., generated by an expert) to determine a cross-validation result that indicates validity (e.g., accuracy) of the classifier generation process.

The cross-validator 112 includes the classifiers to be cross-validated (e.g., one or more of the candidate classifiers 142) and one or more components of the classifier developer 110. For example, the cross-validator 112 includes or has access to the time series representation generator 114, the data filter 116, the batch generator 118, the classifier generator 120, the classifier selector 124, the optimizer 122, or a combination thereof. In a particular example, each of a plurality of the candidate classifiers 142 corresponds to a distinct portion of the time series source data 128, a distinct portion of the time series target data 130, or both, as described with reference to FIG. 6.

The cross-validator 112 cross-validates one or more of the candidate classifiers 142. For example, the cross-validator 112 performs a cross-validation of the classifier 148. To illustrate, the cross-validator 112 uses the classifier 148 to generate one or more classification labels 906 for the time series target data 130. The classifier developer 110 uses the time series target data 130 along with the classification labels 906 as labeled data corresponding to a first domain (e.g., the target asset 106) and the time series source data 128 as unlabeled data corresponding to a second domain (e.g., the source asset 102) to generate a classifier 902 for classifying unlabeled data corresponding to the second domain. For example, the cross-validator 112 provides, to a component of the classifier developer 110 (e.g., the time series representation generator 114), the labeled data corresponding to the first domain and the unlabeled data corresponding to the second domain. In this example, the cross-validator 112 receives, from a component of the classifier developer 110 (e.g., the classifier generator 120, the classifier selector 124, or the optimizer 122), the classifier 902 that is generated based on the labeled data corresponding to the first domain and the unlabeled data corresponding to the second domain.

The classifier 902 generates a set of classification labels 904 for the time series source data 128. The cross-validator 112 compares the set of classification labels 904 generated by the classifier 902 for the second domain (e.g., the source asset 102) to verified classification labels (e.g., the set of classification labels 126) for the second domain to determine an accuracy of the classifier 902 generated by the classifier developer 110. The cross-validator 112 generates a cross-validation result 146 based on the comparison of the set of classification labels 904 and the set of classification labels 126. For example, the cross-validation result 146 indicates a difference between the set of classification labels 126 and the set of classification labels 904. In a particular aspect, the cross-validation result 146 indicating that the difference is below a threshold indicates that the classifier developer 110 is performing as intended (i.e., classifiers generated by the classifier developer 110 are relatively accurate). It should be understood that in other examples, the cross-validator 112 may perform the cross-validation based on chaining multiple classifiers. For example, a first classifier generated by the classifier developer 110 based on labeled data of a first domain is used to label data of a second domain, the labeled data of the second domain is used by the classifier developer 110 to generate a second classifier to label data of a third domain, and the labeled data of the third domain is used by the classifier developer 110 to generate a third classifier to label data of the first domain. The labels generated for the data of the first domain are compared to verified labels (e.g., generated by an expert) of the first domain to determine a first cross-validation result for the classifier 148. In a particular example, the cross-validator 112 generates a second cross-validation result for the classifier 610 by performing similar operations to cross-validate the classifier 610. The cross-validation result 146 indicates the cross-validation results for one or more of the candidate classifiers 142. For example, the cross-validation result 146 indicates the first cross-validation result for the classifier 148, the second cross-validation result for the classifier 610, one or more additional cross-validation results for one or more additional classifiers, or a combination thereof.

In a particular aspect, the cross-validator 112 performs cross-validation on optimized versions of one or more of the candidate classifiers 142. For example, the cross-validator 112 performs cross-validation on an optimized version of the classifier 148 generated by the optimizer 122. In a particular aspect, the cross-validator 112 performs cross-validation on each of the candidate classifiers 142 to generate the cross-validation result 146 for the candidate classifiers 142, and selects the classifier 148 based on determining that the cross-validation result 146 indicates that a first cross-validation result of the classifier 148 indicates a lowest difference from the set of classification labels 126 as compared to cross-validation results corresponding to the remaining classifiers of the candidate classifiers 142. In a particular aspect, the cross-validator 112 outputs the classifier 148 (e.g., the selected classifier) as the classifier for the target asset 106. In a particular aspect, the cross-validator 112 provides the classifier 148 (e.g., the selected classifier) to the optimizer 122. In a particular aspect, the cross-validator 112 provides the cross-validation result 146 corresponding to the candidate classifiers 142 to the optimizer 122. The cross-validator 112 thus enables measuring performance of the classifier developer 110 and estimating accuracy of the generated classifiers.

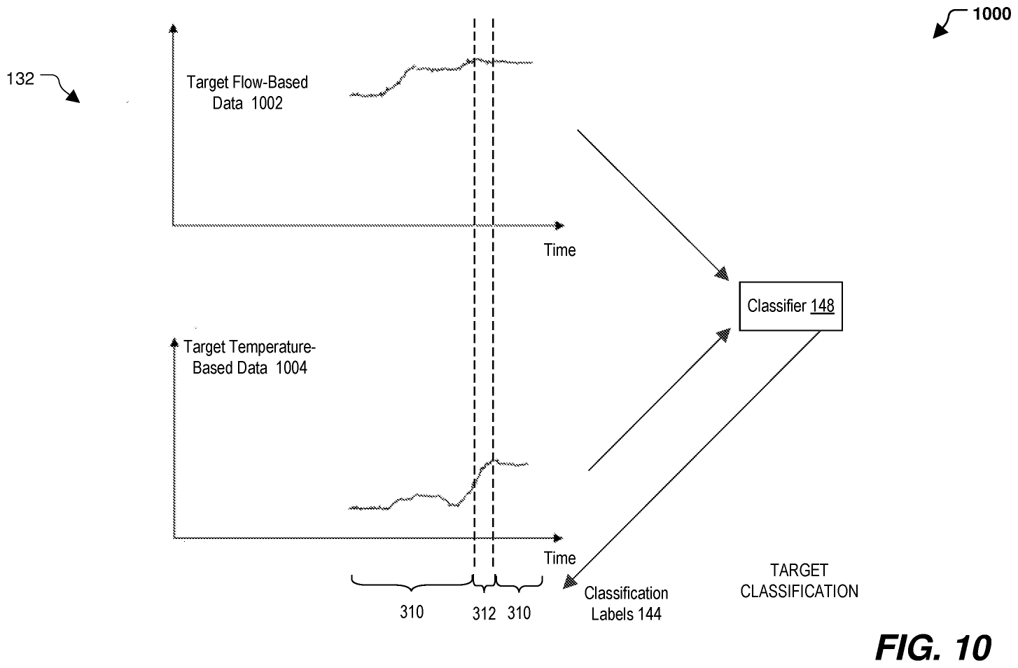

In FIG. 10, an illustrative example of a use of a domain-adapted classifier (e.g., the classifier 148) to classify unlabeled data is shown and generally designated as example 1000. The classifier 148 is used to classify to classify unlabeled data (e.g., time series target data 132 of FIG. 1) of the target sensor(s) 108 to generate one or more classification labels 144.

As an example, the time series target data 132 includes target flow-based data 1002 and target temperature-based data 1004. The classifier 148 assigns the classification label 310 (e.g., regular operation) to each of a first portion of the target flow-based data 306 and a first portion of the target temperature-based data 308 associated with a first time period. Similarly, the classifier 148 assigns the classification label 312 to each of a second portion of the target flow-based data 306 and a second portion of the target temperature-based data 308 associated with a second time period. In a particular aspect, the classification label 312 is assigned to a portion of the time series target data 130 corresponding to a time period during which the target temperature-based data 308 indicates rising temperature and the target flow-based data 306 indicates constant or decreasing flow. The classifier 148 is thus operable to classify unlabeled

Atty. Docket No. 4058-0032 data associated with the target asset 106 without having been trained on any labeled data associated with the target asset 106.

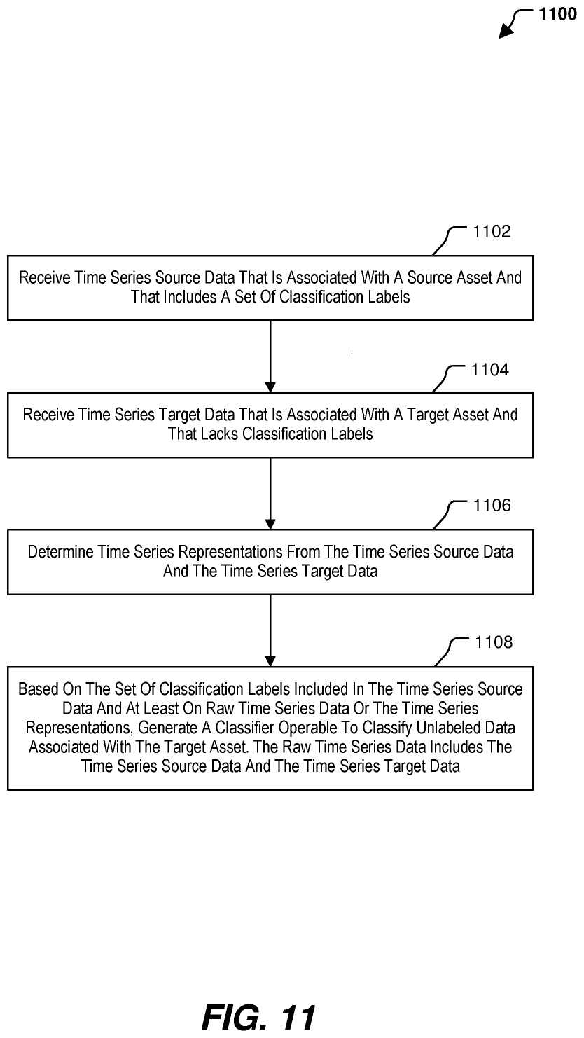

Referring to FIG. 11, a method 1100 of generating a domain-adapted classifier is shown. In a particular aspect, the method 1100 is performed by one or more components described with respect to FIGS. 1-10.

The method 1100 includes receiving time series source data that is associated with a source asset and that includes a set of classification labels, at 1102. For example, the classifier developer 110 receives the time series source data 128 that is associated with the source asset 102 and that includes (or is associated with) the set of classification labels 126, as described with reference to FIG. 1.

The method 1100 also includes receiving time series target data that is associated with a target asset and that lacks classification labels, at 1104. For example, the classifier developer 110 of FIG. 1 receives time series target data 130 that is associated with the target asset 106 and that lacks classification labels, as described with reference to FIG. 1.

The method 1100 further includes determining time series representations from the time series source data and the time series target data, at 1106. For example, the time series representation generator 114 of FIG. 1 determines time series representations 134 from the time series source data 128 and the time series target data 130, as described with reference to FIG. 1.

The method 1100 also includes, based on the set of classification labels included in the time series source data and at least on raw time series data or the time series representations, generating a classifier operable to classify unlabeled data associated with the target asset, at 1108. For example, the classifier generator 120, based on the set of classification labels 126 and at least raw time series data or the time series representations 134, generates the classifier 148 operable to classify unlabeled data associated with the target asset 106, as described with reference to FIG. 1. The raw time series data includes the time series source data 128 and the time series target data 130.

The method 1100 thus enables generation of a domain-adapted classifier operable to classify unlabeled data of the domain. For example, the classifier 148 is operable to classify unlabeled data associated with the target asset 106. The domain-adapted classifier can be generated independently of any labeled data associated with the domain.

The systems and methods illustrated herein may be described in terms of functional block components, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as, but not limited to, C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may take the form of or include a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A method comprising:
receiving time series source data that is associated with a source asset and that includes a set of classification labels;
receiving time series target data that is associated with a target asset and that lacks classification labels;
determining time series representations from the time series source data and the time series target data; and
based on the set of classification labels included in the time series source data and at least on raw time series data or the time series representations, generating a classifier operable to classify unlabeled data associated with the target asset, wherein the raw time series data includes the time series source data and the time series target data.

2. The method of claim 1, further comprising generating a plurality of candidate classifiers based on the time series source data and the time series target data.

3. The method of claim 2, wherein the plurality of candidate classifiers is based on the time series representations.

4. The method of claim 2, wherein a first classifier of the plurality of candidate classifiers is based on a first portion of the time series source data and a first portion of the time series target data, and wherein a second classifier of the plurality of candidate classifiers is based on a second portion of the time series source data and a second portion of the time series target data.

5. The method of claim 2, wherein a first classifier of the plurality of candidate classifiers is based on a first set of hyperparameters and wherein a second classifier of the plurality of candidate classifiers is based on a second set of hyperparameters.

6. The method of claim 2, further comprising:
generating a first cross-validation result by cross-validating a first classifier of the plurality of candidate classifiers;
generating a second cross-validation result by cross-validating a second classifier of the plurality of candidate classifiers; and
selecting the classifier based on a comparison of cross-validation results of the plurality of candidate classifiers.

7. The method of claim 1, further comprising cross-validating the classifier by:
using the classifier to generate a first set of classification labels for the time series target data;
generating one or more additional classifiers, wherein a particular classifier is generated based on first time series data associated with a first asset, a plurality of classification labels associated with the first time series data, and second time series data associated with a second asset, and wherein the particular classifier is operable to classify unlabeled data associated with the second asset;
using a second classifier of the one or more additional classifiers to generate a second set of classification labels for the time series target data; and
generating a cross-validation result based on a comparison of the first set of classification labels and the second set of classification labels.

8. The method of claim 7, further comprising, based at least in part on determining that the cross-validation result satisfies a cross-validation criterion, generating an output indicating the classifier.

9. The method of claim 1, further comprising optimizing the classifier by adjusting one or more model hyperparameters.

10. The method of claim 1, further comprising optimizing the classifier prior to cross-validating the classifier.

11. The method of claim 1, further comprising:
generating a cross-validation result by cross-validating the classifier; and
selectively optimizing the classifier based on the cross-validation result satisfying a cross-validation criterion.

12. The method of claim 1, wherein the classifier is generated based on at least one of a domain separation network (DSN) based technique, a domain confusion soft labels (DCSL) based technique, a transfer learning with deep autoencoders (TLDA) based technique, a domain adversarial training of neural networks (DANN) based technique, a sharing weights for domain adaptation (SWS) based technique, an incrementally adversarial domain adaptation for continually changing environments (IADA) based technique, or a variational fair auto encoder (VFAE) based technique.

13. A computing device comprising:
a processor configured to:
receive time series source data that is associated with a source asset and that includes a set of classification labels;
receive time series target data that is associated with a target asset and that lacks classification labels;
determine time series representations from the time series source data and the time series target data; and
based on the set of classification labels included in the time series source data and at least on raw time series data or the time series representations, generate a classifier operable to classify unlabeled data associated with the target asset, wherein the raw time series data includes the time series source data and the time series target data.

14. The computing device of claim 13, wherein the processor is further configured to generate a plurality of candidate classifiers based on the time series source data and the time series target data.

15. The computing device of claim 14, wherein a first classifier of the plurality of candidate classifiers is based on a first portion of the time series source data and a first portion of the time series target data, and wherein a second classifier of the plurality of candidate classifiers is based on a second portion of the time series source data and a second portion of the time series target data.

16. The computing device of claim 13, wherein the processor is further configured to cross-validate the classifier by:
using the classifier to generate a first set of classification labels for the time series target data;
generating one or more additional classifiers, wherein a particular classifier is generated based on first time series data associated with a first asset, a plurality of classification labels associated with the first time series data, and second time series data associated with a second asset, and wherein the particular classifier is operable to classify unlabeled data associated with the second asset;
using a second classifier of the one or more additional classifiers to generate a second set of classification labels for the time series target data; and
generating a cross-validation result based on a comparison of the first set of classification labels and the second set of classification labels.

17. The computing device of claim 16, wherein the processor is further configured to, based at least in part on determining that the cross-validation result satisfies a cross-validation criterion, generate an output indicating the classifier.

18. The computing device of claim 13, wherein the classifier is generated based on at least one of a domain separation network (DSN) based technique, a domain confusion soft labels (DCSL) based technique, a transfer learn with deep autoencoders (TLDA) based technique, a domain adversarial training of neural networks (DANN) based technique, a sharing weights for domain adaptation (SWS) based technique, an incrementally adversarial domain adaptation for continually changing environments (IADA) based technique, or a variational fair auto encoder (VFAE) based technique.

19. A computer-readable storage device storing instructions that when executed by a processor, cause the processor to:
receive time series source data that is associated with a source asset and that includes a set of classification labels;
receive time series target data that is associated with a target asset and that lacks classification labels;
determine time series representations from the time series source data and the time series target data; and
based on the set of classification labels included in the time series source data and at least on raw time series data or the time series representations, generate a classifier operable to classify unlabeled data associated with the target asset, wherein the raw time series data includes the time series source data and the time series target data.

20. The computer-readable storage device of claim 19, wherein the instructions, when executed by the processor, further cause the processor to generate a plurality of candidate classifiers based on the time series representations.
